(19) United States
(12) Patent Application Publication
(10) Pub. No.: US 2024/0423270 A1
(43) Pub. Date: Dec. 26, 2024

(54) CARTRIDGE FOR AEROSOL-GENERATING DEVICE WITH AXIAL AND ROTATIONAL MOVEMENT

(71) Applicant: Philip Morris Products S.A., Neuchatel (CH)

(72) Inventors: Rui Nuno Rodrigues Alves BATISTA, Morges (CH); Alexandra SEREDA, Neuchâtel (CH)

(73) Assignee: Philip Morris Products S.A., Neuchatel (CH)

(21) Appl. No.: 18/700,389

(22) PCT Filed: Oct. 19, 2022
(86) PCT No.: PCT/EP2022/079021

§ 371 Date: Apr. 11, 2024

(30) Foreign Application Priority Data
Oct. 20, 2021 (EP) 21203689.1
Nov. 9, 2021 (EP) 21207060.1

(51) Int. Cl. A24F 40/42; A24F 40/10; A24F 40/44; A24F 40/465; A24F 40/485; A24F 40/49

(52) U.S. Cl. CPC A24F 40/42; A24F 40/10; A24F 40/44; A24F 40/465; A24F 40/485; A24F 40/49

(57) ABSTRACT

A cartridge for an aerosol-generating device is provided, including: a mouthpiece including a first fluid-permeable portion and a first air inlet; and a liquid storage portion including a reservoir to hold a liquid aerosol-forming substrate, a second fluid-permeable portion in fluid contact with the reservoir, and a second air inlet, the mouthpiece and the liquid storage portion being axially movable with respect to each other, a degree of contact between the first fluid-permeable portion and the second fluid-permeable portion being controllable by the axial movement between the mouthpiece and the liquid storage portion, the mouthpiece and the liquid storage portion being rotationally movable with respect to each other, and a degree of overlap between the first air inlet and the second air inlet being controllable by rotational movement between the mouthpiece and the liquid storage portion. An aerosol-generating system including the cartridge and an aerosol-generating device is also provided.

The present invention relates to a cartridge for an aerosol-generating device.

It is known to provide a cartridge for an aerosol-generating device for generating an inhalable vapor. The cartridge may comprise aerosol-forming substrate in liquid form. Such devices may heat the aerosol-forming substrate to a temperature at which one or more components of the aerosol-forming substrate are volatilised without burning the aerosol-forming substrate. The cartridge may be configured insertable into a cavity, such as a heating chamber, of the aerosol-generating device. A heating element may be arranged in or around the heating chamber for heating the aerosol-forming substrate once the cartridge is inserted into the heating chamber of the aerosol-generating device.

A user may carry an aerosol-generating device including a cartridge. The aerosol-generating device may be carried for example in a pocket or in a bag. Friction with other elements located in the pocket or bag may accidentally turn the movable parts of the aerosol-generating device. This may lead to an accidental activation of the aerosol-generating device. This may lead to an accidental spill-over of aerosol-forming substrate out of the aerosol-generating device.

It would be desirable to have a cartridge for an aerosol-generating device enabling modification of the generated aerosol. It would be desirable to have a cartridge for an aerosol-generating device enabling control of the amount of aerosol generated. It would be desirable to have a cartridge for an aerosol-generating device that prevents undesired aerosol generation. It would be desirable to provide a cartridge for an aerosol-generating device avoiding undesired leakage of the aerosol-forming substrate.

According to an embodiment of the invention there is provided a cartridge for an aerosol-generating device. The cartridge may comprise a mouthpiece. The mouthpiece may comprise a first fluid permeable portion, and a first air inlet. The cartridge may also comprise a liquid storage portion. The liquid storage portion may comprise a reservoir for holding liquid aerosol-forming substrate. The liquid storage portion also may comprise a second fluid permeable portion in fluid contact with the reservoir. Additionally, the liquid storage portion may comprise a second air inlet. The mouthpiece and the liquid storage portion may be axially movable with respect to each other, wherein a degree of contact between the first fluid permeable portion and the second fluid permeable portion may be controllable by the axial movement between the mouthpiece and the liquid storage portion. Furthermore, the mouthpiece and the liquid storage portion may be rotationally movable with respect to each other, wherein the degree of overlap between the first air Inlet and the second air inlet may be controllable by the rotational movement between the mouthpiece and the liquid storage portion.

According to a further embodiment of the invention there is provided a cartridge for an aerosol-generating device. The cartridge comprises a mouthpiece. The mouthpiece comprises a first fluid permeable portion, and a first air inlet. The cartridge also comprises a liquid storage portion. The liquid storage portion comprises a reservoir for holding liquid aerosol-forming substrate. The liquid storage portion also comprises a second fluid permeable portion in fluid contact with the reservoir, and a second air inlet. The mouthpiece and the liquid storage portion are axially movable with respect to each other, wherein a degree of contact between the first fluid permeable portion and the second fluid permeable portion is controllable by the axial movement between the mouthpiece and the liquid storage portion. Furthermore, the mouthpiece and the liquid storage portion are rotationally movable with respect to each other, wherein the degree of overlap between the first air Inlet and the second air inlet is controllable by the rotational movement between the mouthpiece and the liquid storage portion.

The axial movement between the mouthpiece and the liquid storage portion may determine a degree of contact between the first fluid permeable portion and the second fluid permeable portion. This degree of contact may determine the amount of liquid aerosol-forming substrate used for the generation of an aerosol. This may enable a user to manipulate the composition of the aerosol by axially moving the mouthpiece relative to the liquid storage portion.

A degree of overlap between the first air inlet and the second air inlet may be controllable by rotationally moving the mouthpiece with respect to the liquid storage portion. This degree of overlap may determine the amount of air employed for the generation of an aerosol. This may enable a user to manipulate the formation of the aerosol by rotationally moving the mouthpiece with respect to the liquid storage portion.

The combination of axially and rotationally moving the mouthpiece relative to the liquid storage portion also may prevent unintentional spilling of the aerosol-forming substrate. In particular, a cartridge may be held in a position during storage, wherein no contact between the first fluid permeable portion and the second fluid permeable portion is established. Additionally, the cartridge may be held in a position during storage wherein no overlap exists between the first air Inlet and the second air inlet. This may reduce the risk of unintentional leakage of aerosol-forming substrate out of the cartridge during storage. This may improve the shelf-life of the cartridge.

The first fluid permeable portion may be tubular. This may allow for an easy axial movement of the first fluid permeable portion of the cartridge relative to the second fluid permeable portion of the liquid storage portion.

The first fluid permeable portion may be configured as a wick. This may allow the transport of liquid aerosol-forming substrate via capillary forces.

The second fluid permeable portion of the liquid storage portion may be tubular. This may allow an easy axial movement of the second fluid permeable portion relative to the first fluid permeable portion of the mouthpiece.

The second fluid permeable portion may be configured as a wick. This may allow the transport of the liquid aerosol-forming substrate from the second fluid permeable portion towards the first fluid permeable portion via capillary forces.

One or both of the first fluid permeable portion and the second fluid permeable portion may comprise a high retention and release material.

The high retention material may include a capillary material having a fibrous or porous structure which forms a plurality of small bores or micro-channels. Liquid aerosol-forming substrate may be transported through the capillary material by capillary action. The high retention material may include a plurality of fibers, threads, or other fine bore tubes that form a bundle of capillaries. The fibers or threads may be generally aligned to convey liquid aerosol-forming substrate towards the transport material. Alternatively, the retention material may include sponge-like or foam-like material. The retention material may include any suitable material or combination of materials. Examples of suitable materials include a sponge or foam material, ceramic- or graphite-based materials in the form of fibers or sintered powders, foamed metal or plastic materials, fibrous materials (for example, spun or extruded fibers, such as cellulose acetate, polyester, bonded polyolefin, polyethylene, polypropylene fibers, nylon fibers, ceramic fibers), cotton and combinations thereof. In one exemplary embodiment, the retention material includes high density polyethylene (HDPE) or polyethylene terephthalate (PET).

One or both of the first fluid permeable portion and the second fluid permeable portion may comprise a ceramic porous material. The porous material may have a porosity of about 30 percent to 70 percent, preferably of about 40 percent to 60 percent. The pore size may be from 5 micrometer to 40 micrometer, preferably from 5 micrometer to 30 micrometer.

The mouthpiece may comprise a tubular airflow channel. The first fluid permeable portion may be arranged at the distal portion of the tubular airflow channel. This may allow liquid aerosol-forming substrate to enter the tubular airflow channel via the first fluid permeable portion. This may provide an airflow channel for the generated aerosol towards the downstream end of the mouthpiece.

As used herein, the terms “distal”, and “proximal”, are used to describe the relative positions of sections of the cartridge or of an aerosol-generating device used together with the aerosol-generating article in relation to the direction in which the aerosol is transported through the aerosol-generating article during use. The cartridge or the aerosol-generating device according to the invention comprises a proximal end through which, in use, an aerosol exits the cartridge. The proximal end of the cartridge may also be referred to as the mouth end or the downstream end. In use, a user draws on the downstream or mouth end of the cartridge in order to inhale an aerosol generated by the aerosol-generating system. The aerosol-generating system comprises an upstream end opposed to the downstream or mouth end. The mouth end is downstream of the distal end. The distal end of the aerosol-generating device or the cartridge may also be referred to as the upstream end. Components, or portions of components, of the cartridge or the aerosol-generating device may be described as being upstream or downstream of one another based on their relative positions to the direction in which the aerosol is transported through the cartridge or the aerosol-generating device during use of the cartridge or the aerosol generating device.

The mouthpiece may comprise a first sealing element arranged distal of the first fluid permeable portion. This may prevent liquid aerosol-forming substrate to spill out of the mouthpiece through the first fluid permeable portion in a distal direction. Preferably, the first sealing element is configured as a tubular sealing element. This may provide a particular reliable sealing of the first fluid permeable portion with regard to the distal end of the mouthpiece. This may also provide a reliable sealing of the second fluid permeable portion when the second fluid permeable portion is sealingly covered by the first sealing element.

The mouthpiece may comprise a second sealing element arranged proximal of the first fluid permeable portion. This may prevent liquid aerosol-forming substrate to spill out of the mouthpiece through the first fluid permeable portion in a proximal direction. Preferably, the second sealing element is configured as a ring-shaped sealing element. This may provide a particular reliable sealing of the first fluid permeable portion with regard to the proximal end of the mouthpiece. This also may allow for an easy axial movement of the mouthpiece relative to the liquid storage portion.

In a further embodiment of the cartridge, the mouthpiece and the liquid storage portion may be axially movable with respect to each other in a first position. In this first position the first sealing element may sealingly cover the second fluid permeable portion of the liquid storage portion.

This may allow a reliable sealing of the second fluid permeable portion of the liquid storage portion by the first sealing element of the mouthpiece. This may allow a reliable storing of the cartridge in the first position.

In a further embodiment of the cartridge the mouthpiece and the liquid storage portion may be axially movable with respect to each other in a second position. In the second position the first fluid permeable portion may contact a whole inner surface of the second fluid permeable portion.

In the second position the maximum amount of liquid aerosol-forming substrate may be able to exit the reservoir for holding the liquid aerosol-forming substrate via the second fluid permeable portion and may further be transported to the first fluid permeable portion of the mouthpiece. This may be due to the first fluid permeable portion contacting the whole inner surface of the second fluid permeable portion. This may provide the maximal surface between the first fluid permeable portion and the second fluid permeable portion for transporting the liquid aerosol-forming substrate.

The mouthpiece and the liquid storage portion may be configured to be incrementally axially movable between the first position and the second position to an intermediate axial position wherein the first fluid permeable portion only partially contacts the whole inner surface of the second fluid permeable portion in the intermediate axial position. The mouthpiece and the liquid storage portion may be configured to be axially movable with respect to each other to a range of intermediate positions between the first position and the second position. In an intermediate third position, the first fluid permeable portion may contact only one third of the whole inner surface of the second fluid permeable portion. In an intermediate fourth position, the first fluid permeable portion may contact half of the whole inner surface of the second fluid permeable portion. In an intermediate fifth position the first fluid permeable portion may contact three quarters of the whole inner surface of the second fluid permeable portion. These intermediate axial position may allow less than the maximum amount of liquid aerosol-forming substrate to be passed through the first fluid permeable portion and the second fluid permeable portion. Many additional intermediate positions are possible between the mentioned intermediate third position, intermediate fourth position and intermediate fifth position. The cartridge of the present invention may be provided with range of different preset settings. These preset settings may allow user to lock the cartridge in different settings corresponding for example to various of the above-described intermediate axial positions or the first and second position.

In this context the term “first position” refers to an axial position of the mouthpiece with regard to the liquid storage portion, wherein the first fluid permeable portion of the mouthpiece does not contact the surface of the second fluid permeable portion of the reservoir.

The first air inlet may enable lateral airflow into the mouthpiece. This may allow a user to control the airflow into the mouthpiece by rotationally moving the mouthpiece with respect to the liquid storage portion.

The liquid storage portion of the cartridge may comprise a central tubular cavity for at least partly receiving the mouthpiece. This may allow for a particular easy assembly of the mouthpiece and the liquid storage portion in the cartridge. In particular, the central tubular cavity of the liquid storage portion may be configured to at least partly receive the tubular airflow channel of the mouthpiece. This may allow for a particular easy axial movement of the mouthpiece with respect to the liquid storage portion by inserting the tubular airflow channel of the mouthpiece in the central tubular cavity of the liquid storage portion. This may also enable an easy rotational movement of the mouthpiece relative to the liquid storage portion.

The second air inlet of the liquid storage portion may enable lateral airflow into the central tubular cavity of the liquid storage portion. This may allow air to enter the central tubular cavity of the liquid storage portion via the second air inlet through the first air inlet. This may furthermore allow the air to enter the tubular airflow channel of the mouthpiece through the central tubular cavity of the liquid storage portion.

The first air inlet may enable lateral airflow towards the second air inlet, when the mouthpiece is received in the central tubular cavity of the liquid storage portion and when the first air Inlet and the second air inlet overlap.

This may provide an airflow path into the central cavity of the liquid storage portion through the first air Inlet and the second air inlet.

In a further embodiment of the cartridge, the mouthpiece and the liquid storage portion may be rotationally movable with respect to each other in a sixth position. In this sixth position, the first air Inlet and the second air inlet may not overlap, thereby preventing airflow through the central tubular cavity into the mouthpiece.

The mouthpiece and the liquid storage portion may be rotationally movable with respect to each other in a seventh position, in which the first air inlet and the second air inlet fully overlap thereby allowing airflow into the mouthpiece.

The mouthpiece and the liquid storage portion may be incrementally rotationally movable between the sixth position to the seventh position to an intermediate rotational position wherein the first air Inlet and the second air inlet partially overlap in the intermediate rotational position.

A user therefore may be able to incrementally rotationally move the mouthpiece relative to the liquid storage portion from the sixth position to the seventh position wherein the maximum amount of air flows into the mouthpiece in the seventh position.

In particular, the mouthpiece may be moved relative to the liquid storage portion to an intermediate eighth position, wherein the first air inlet and the second air inlet only overlap with one quarter of the fully overlap of the seventh position. The mouthpiece may be moved relative to the liquid storage portion to an intermediate nineth position, wherein the first air inlet and the second air inlet only overlap with half of the fully overlap of the seventh position. The mouthpiece may be moved relative to the liquid storage portion to an intermediate tenth position, wherein the first air inlet and the second air inlet only overlap with three quarters of the fully overlap present in the seventh position. These intermediate rotational postions would allow less than the maximum amount of air to pass into the mouthpiece.

Many additional intermediate positions are possible between the mentioned intermediate eighth position, intermediate nineth position and intermediate tenth position. The cartridge of the present invention may be provided with range of different preset settings. These preset settings may allow user to lock the cartridge in different settings corresponding for example to various of the above-described intermediate rotational positions or the sixth and seventh position.

This may allow a user to incrementally regulate the flow of air into the mouthpiece by incrementally rotating the mouthpiece and the liquid storage portion.

The components of the cartridge, including the mouthpiece and the liquid storage portion can be made from polymeric components. For example, one or more of nylon, PBT (Polybutylene terephthalate) polyesters, and TPE's (thermoplastic elastomer) may be used.

In a further embodiment of the cartridge, the mouthpiece may comprise a susceptor. The susceptor may be configured to inductively heat the liquid aerosol-forming substrate for aerosol formation. Preferably, the susceptor is tubular. Preferably the susceptor may be aligned with the first fluid permeable portion of the mouthpiece. The susceptor may be in fluid communication with the first fluid permeable portion of the mouthpiece. The susceptor may be porous. This may allow liquid aerosol-forming substrate to pass through the susceptor while being heated by the susceptor. The susceptor may be in fluid communication with the tubular airflow channel of the mouthpiece. This may allow the transport of the liquid aerosol-forming substrate through the susceptor into the tubular airflow channel for generation of an aerosol.

In particular, this may allow the liquid aerosol-forming substrate to pass through the susceptor while being heated. The liquid aerosol-forming substrate may pass out of the liquid storage portion into the second fluid permeable portion through the first fluid permeable portion through the susceptor and into the tubular airflow channel of the mouthpiece. In the tubular airflow channel the heated liquid aerosol-forming substrate may be mixed with air coming from the central tubular cavity of the liquid storage portion to form the aerosol.

The susceptor may be formed from any material that can be inductively heated to a temperature sufficient to generate an aerosol from the aerosol-forming substrate. A preferred susceptor may comprise or consist of a ferromagnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius.

Preferred susceptors are metal susceptors, for example stainless steel. However, susceptor materials may also comprise or be made of graphite, molybdenum, silicon carbide, aluminum, niobium, Inconel alloys (austenite nickel-chromium-based superalloys), metallized films, ceramics such as for example zirconia, transition metals such as for example iron, cobalt, nickel, or metalloids components such as for example boron, carbon, silicon, phosphorus, aluminium.

The porous susceptor may comprise or consist of an electrically conductive ceramic material, such as lanthanum-doped strontium titanate, or yttrium-doped strontium titanate. Porous inductively heatable ceramic material may be a ceramic ferrite. The porous susceptor may comprise or consist of an open-porous ferrimagnetic or ferromagnetic ceramic material, such as a ceramic ferrite. As used herein, ferrites are ferrimagnetic ceramic compounds derived from iron oxides such as hematite (Fe₂O₃) or magnetite (Fe₃O₄) as well as oxides of other metals.

A stainless-steel mesh may be used as a porous susceptor.

The porous susceptor may have a porosity of between 35 percent to 80 percent preferably between 45 percent to 65 percent, most preferably between 50 percent to 60 percent. As used herein, the term ‘porosity’ refers to a fraction of void space in a susceptor. The porosity of the susceptor may be chosen to enable lateral airflow through the susceptor. The porosity may additionally or alternatively be influenced by providing slits or holes in the susceptor.

The liquid aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The liquid aerosol-forming substrate may comprise other additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5 percent and about 10 percent, for example about 2 percent.

The invention also provides an aerosol-generating system comprising the cartridge as described herein. The aerosol-generating system furthermore may comprise an aerosol-generating device, wherein the aerosol-generating device may comprise a cavity for receiving the cartridge.

According to a further embodiment of the present invention an aerosol-generating system is provided. The aerosol-generating system comprises a cartridge as described herein. Furthermore, the aerosol-generating system comprises an aerosol-generating device. The aerosol-generating device comprises a cavity for receiving the cartridge.

The aerosol-generating device of the aerosol-generating system may provide a heating element. The heating element may be configured to heat the liquid aerosol-forming substrate for generating an aerosol.

The heating element may comprise an inductor coil. The inductor coil may be configured to heat the susceptor of the mouthpiece. This may enable a heating of the liquid aerosol-forming substrate via inductive heating for generating an aerosol.

The inductor coil of the heating element may at least partly surround the cavity for receiving the cartridge.

This may allow inductor coil to heat the susceptor of the mouthpiece when the cartridge is fully received in the cavity.

The susceptor of the mouthpiece may be configured to be alignable with respect to the inductor coil of the heating element of the aerosol-generating device by axially moving the mouthpiece with respect to the aerosol-generating device when the cartridge is fully received in the cavity of the aerosol-generating device. A degree of horizontal alignment between the inductor coil and the susceptor of the mouthpiece may determine a degree of heating of the susceptor.

Upon inductive heating the susceptor may be heated by the alternating magnetic field of the inductive heating element. This may also heat the liquid aerosol-forming substrate being adjacent to or being transported through the susceptor. For induction heating, the heating element preferably comprises an induction coil. An alternating current may be supplied to the induction coil for generating an alternating magnetic field. The alternating current may have a high frequency. As used herein, the term “high frequency oscillating current” means an oscillating current having a frequency of between 500 kilohertz and 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

The aerosol-generating device may comprise a power supply, typically a battery, within the casing of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The aerosol-generating device may comprise electric circuitry. The electric circuitry may comprise a microprocessor, which may be a programmable microprocessor. The microprocessor may be part of a control unit. The electric circuitry may comprise further electronic components. The electric circuitry may be configured to regulate a supply of power to the heating element, particularly to the resistive heating element or the conductive heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The invention furthermore provides a method for controlling the aerosol generation in the aerosol-generating system described herein. The method may comprise axially moving the mouthpiece and the liquid storage portion with respect to each other thereby controlling the supply of liquid aerosol-forming substrate. The method also may comprise rotationally moving the mouthpiece and the liquid storage portion with respect to each other thereby controlling the airflow into the mouthpiece.

According to the further embodiment of the invention a method for controlling the aerosol generation in the aerosol-generating system described herein is provided. The method comprises axially moving the mouthpiece and the liquid storage portion with respect to each other, thereby controlling the supply of liquid aerosol-forming substrate. Furthermore, the method comprises rotationally moving the mouthpiece and the liquid storage portion with respect to each other thereby controlling the airflow into the mouthpiece.

Such a method may provide a user with different options for manipulating the generation of aerosol in the aerosol-generating system. This may be done by axially and rotationally moving the mouthpiece and the liquid storage portion with respect to each other.

Below, there is provided a non-exhaustive list of non-limiting examples. Any one or more of the features of these examples may be combined with any one or more features of another example, embodiment, or aspect described herein.

Example Ex1: A cartridge for an aerosol-generating device, the cartridge comprising:
a mouthpiece, the mouthpiece comprising
a first fluid permeable portion, and
a first air inlet, and
a liquid storage portion, the liquid storage portion comprising
a reservoir for holding liquid aerosol-forming substrate,
a second fluid permeable portion in fluid contact with the reservoir, and
a second air inlet,
wherein the mouthpiece and the liquid storage portion are axially movable with respect to each other, wherein a degree of contact between the first fluid permeable portion and the second fluid permeable portion is controllable by the axial movement between the mouthpiece and the liquid storage portion, wherein the mouthpiece and the liquid storage portion are rotationally movable with respect to each other, wherein a degree of overlap between the first air inlet and the second air inlet is controllable by the rotational movement between the mouthpiece and the liquid storage portion.

Example Ex2: The cartridge according to example Ex1, wherein the first fluid permeable portion is tubular.

Example Ex3: The cartridge according to any of the preceding examples, wherein the first fluid permeable portion is configured as a wick.

Example Ex4: The cartridge according to any of the preceding examples, wherein the second fluid permeable portion is tubular.

Example Ex5: The cartridge according to any of the preceding examples, wherein the second fluid permeable portion is configured as a wick.

Example Ex6: The cartridge according to any of the preceding examples, wherein the mouthpiece comprises a tubular airflow channel, and wherein the first fluid permeable portion is arranged at a distal portion of the tubular airflow channel.

Example Ex7: The cartridge according to any of the preceding examples, wherein the mouthpiece comprises a first sealing element arranged distal of the first fluid permeable portion, preferably wherein the first sealing element is configured as a tubular sealing element.

Example Ex8: The cartridge according to the preceding example, wherein the mouthpiece and the liquid storage portion are axially movable with respect to each other in a first position, in which the first sealing element sealingly covers the second fluid permeable portion of the liquid storage portion.

Example Ex9: The cartridge according to any of the preceding examples, wherein the mouthpiece and the liquid storage portion are axially movable with respect to each other in a second position, in which the first fluid permeable portion contacts a whole inner surface of the second fluid permeable portion.

Example Ex10: The cartridge according to the preceding examples Ex8 or Ex9, wherein the mouthpiece and the liquid storage portion are incrementally axially movable between the first and the second position to an intermediate axial position wherein the first fluid permeable portion only partially contacts the whole inner surface of the second fluid permeable membrane in the intermediate axial position.

Example Ex11: The cartridge according to any of the preceding examples, wherein the mouthpiece comprises a second sealing element arranged proximal of the first fluid permeable portion, preferably wherein the second sealing element is configured as a ring-shaped sealing element.

Example Ex12: The cartridge according to any of the preceding examples, wherein the first air inlet enables lateral airflow into the mouthpiece.

Example Ex13: The cartridge according to any of the preceding examples, wherein the liquid storage portion comprises a central tubular cavity for at least partly receiving the mouthpiece.

Example Ex14: The cartridge according to the preceding example, wherein the second air inlet enables lateral airflow into the central tubular cavity of the liquid storage portion.

Example Ex15: The cartridge according to the preceding example, wherein the first air inlet enables lateral airflow towards the second air inlet, when the mouthpiece is received in the central tubular cavity of the liquid storage portion.

Example Ex16: The cartridge according to any of the preceding examples, wherein the mouthpiece and the liquid storage portion are rotationally movable with respect to each other in a sixth position, in which the first air inlet and the second air inlet do not overlap thereby preventing airflow into the mouthpiece.

Example Ex17: The cartridge according to any of the preceding examples, wherein the mouthpiece and the liquid storage portion are rotationally movable with respect to each other in a seventh position, in which the first air inlet and the second air inlet fully overlap thereby allowing airflow into the mouthpiece.

Example Ex18: The cartridge according to the examples Ex16 or Ex17, wherein the mouthpiece and the liquid storage portion are incrementally rotationally movable between the sixth position and the seventh position to an intermediate rotational position wherein the first air inlet and the second air inlet partially overlap in the intermediate rotational position.

Example Ex19: The cartridge according to any of the preceding examples, wherein the mouthpiece comprises a susceptor, wherein the susceptor is preferably tubular and aligned with the first fluid permeable portion, preferably wherein the susceptor is porous, more preferably wherein the susceptor is in fluid communication with the first fluid permeable portion.

Example Ex20: An aerosol-generating system comprising the cartridge of any of the preceding examples and an aerosol-generating device, wherein the aerosol-generating device comprises a cavity for receiving the cartridge.

Example Ex21: The aerosol-generating system of example Ex20, wherein the aerosol-generating device comprises a heating element.

Example Ex22: The aerosol-generating system of the preceding example Ex21, wherein the heating element comprises an inductor coil.

Example Ex23: The aerosol-generating system of the preceding example, wherein the inductor coil at least partly surrounds the cavity.

Example Ex24: A method for controlling the aerosol generation in an aerosol-generating system of any of the examples Ex20 to Ex23, the method comprising
axially moving the mouthpiece and the liquid storage portion with respect to each other thereby controlling the supply of liquid aerosol-forming substrate, and
rotationally moving the mouthpiece and the liquid storage portion with respect to each other thereby controlling the airflow into the mouthpiece.

Features described in relation to one embodiment may equally be applied to other embodiments of the invention.

The invention will be further described, by way of example only, with reference to the accompanying drawings in which:

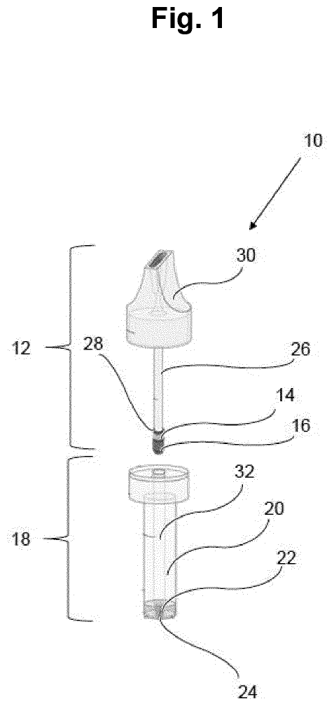

FIG. 1 shows a perspective view of one embodiment of a cartridge in accordance with the present invention;

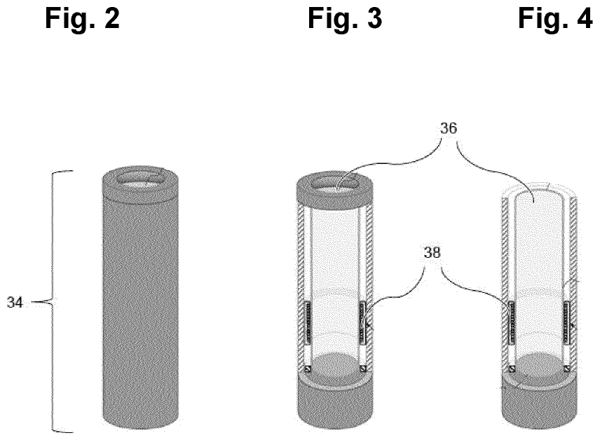

FIGS. 2 to 4 show perspective views of an aerosol-generating device used with cartridge of the present invention;

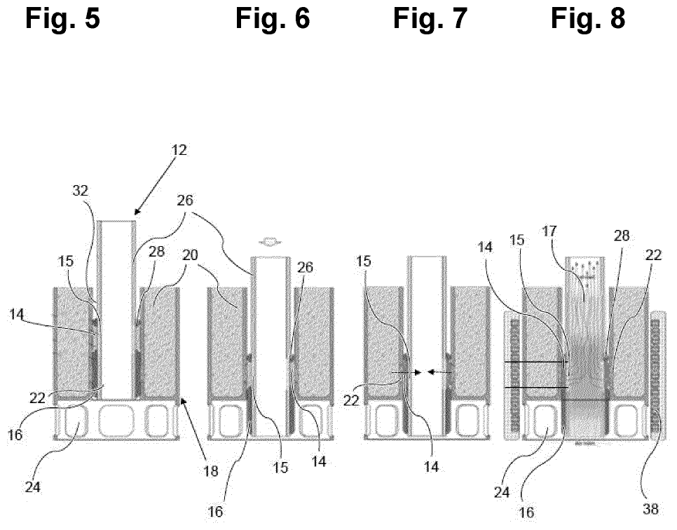

FIGS. 5 to 8 show cross-sectional views of the assembled cartridge including the mouthpiece inserted into the liquid storage portion at different positions;

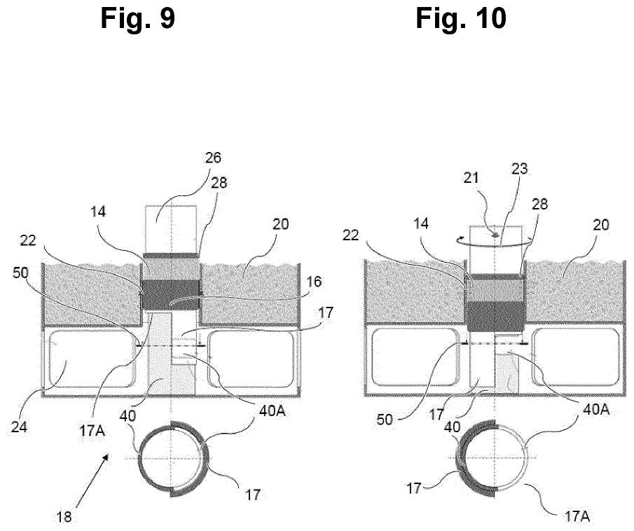

FIGS. 9 and 10 depict cross-sectional views of the assembled cartridge in different positions; and

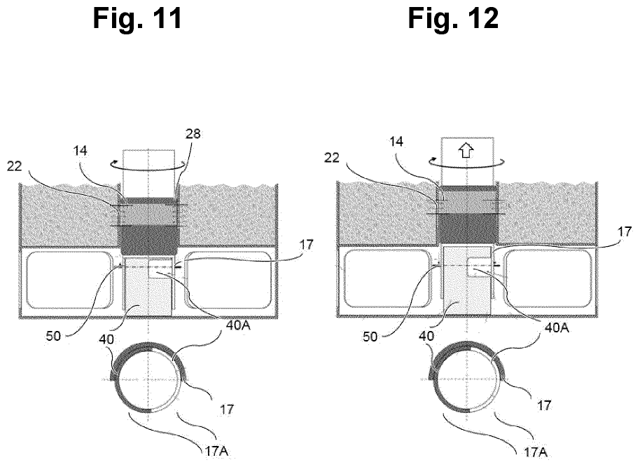

FIGS. 11 and 12 show cross-sectional views of the assembled cartridge including the mouthpiece and the liquid storage portion in further different positions. In the following the same elements are marked with the same reference numerals throughout all the figures.

FIG. 1 shows a perspective view of a cartridge 10 in accordance with the present invention. The cartridge 10 comprises a mouthpiece 12 and the liquid storage portion 18. The mouthpiece 12 comprises a mouthpiece cover 30 which is fluidly connected to the tubular airflow channel 26. At the distal end of the tubular airflow channel 26 a first fluid permeable portion 14 is present. This first fluid permeable portion 14 is flanked by first sealing element 16 and the second sealing element 28, which both can provide sealing, so that liquid aerosol-forming substrate being transported through the first fluid permeable portion does not accidentally spill out of the first fluid permeable portion. The mouthpiece 12, in particular its tubular airflow channel 26 can be inserted into the central tubular cavity 32 of the liquid storage portion 18. This central tubular cavity 32 is surrounded by tubular reservoir 24 holding liquid aerosol-forming substrate. The second fluid permeable portion 22 is present at a distal end of the liquid storage portion 18. This second fluid permeable portion 22 is in fluid communication with the liquid aerosol-forming substrate of the reservoir 20. At the distal end of the liquid storage portion 18 outer air inlets 24 are present, which allow ambient air to enter the liquid storage portion.

FIGS. 2 to 4 depict an aerosol-generating device 34 including a cavity 36 for receiving the cartridge 10. In particular, the mouthpiece may be introduced into the liquid storage portion 18 of the cartridge 10. This cartridge 36 may then be received in the cavity 36 of the aerosol-generating device 34. The aerosol-generating device 34 also includes an inductor coil 38, which is configured to heat a susceptor portion present in the cartridge, in particular in the mouthpiece, as described below, in order to provide an aerosol to a user.

FIG. 5 depicts the lower part of the cartridge 10 wherein the tubular airflow channel 26 of the mouthpiece 10 is partly inserted into the central tubular cavity 32 of the liquid storage portion. FIG. 5 shows the first position in which the first sealing element 16 sealingly covers the second fluid permeable portion of the liquid storage portion. This first position therefore prevents the transport of liquid aerosol-forming substrate from the reservoir 20 to the mouthpiece. A cartridge in accordance with the present invention may be marketed and sold in such a position, which reliably retains the liquid aerosol-forming substrate in the reservoir 20. Tubular airflow channel 26 of the mouthpiece 12 also includes the first fluid permeable portion 14, which is fluidly connected with the tubular porous susceptor 15. The first fluid permeable portion is fluidly connected to the tubular porous susceptor. Neither the first fluid permeable portion 14 nor the tubular susceptor 15 are in fluid contact with the second fluid permeable portion 22 of the reservoir 20, so that the liquid aerosol-forming substrate is retained in the reservoir. The lower part of the liquid storage portion 18 also includes outer air inlets 24 for air to pass from the cavity of the aerosol-generating device into the interior of the cartridge.

FIG. 6 shows the lower part of the cartridge 10 after the tubular airflow channel 26 of the mouthpiece has been completely inserted into the central tubular cavity by an axial movement of the mouthpiece relative to the liquid storage portion as shown by the arrow. In this second position the first fluid permeable portion 14 is in full fluid communication with the second fluid permeable portion 22 of the reservoir 20. This second position allows liquid aerosol-forming substrate to exit the reservoir 20 through the second fluid permeable portion 22 into the first fluid permeable portion 14 and through the tubular porous susceptor 15 of the tubular airflow channel 26. The transport of the liquid aerosol-forming substrate through the second fluid permeable portion, the first fluid permeable portion and the porous susceptor is indicated by the dashed arrows in FIG. 7.

FIG. 8 depicts the generation of the aerosol 17 in the tubular airflow channel 26 of the mouthpiece when the tubular porous susceptor 15 is heated by the inductor coil 38 of the aerosol-generating device. The liquid aerosol-forming substrate is transported from the reservoir 20 through the second fluid permeable portion 22 of the liquid storage portion to the first fluid permeable portion 14 of the mouthpiece. Subsequently, the liquid aerosol-forming substrate passes through the porous susceptor element 15 and is heated. In the tubular airflow channel 26 the evaporated aerosol-forming substrate is mixed with air entering the airflow channel through the outer air inlets 24 and first and second air inlets so that the aerosol 17 is formed (first and second air inlets not shown in FIG. 6). The second sealing element 28 and the first sealing element 16 of the mouth piece prevent any liquid aerosol-forming substrate from spilling into the central tubular cavity 32 of the cartridge.

FIG. 9 shows in the upper part a cross-sectional view of the lower part of the cartridge in the first axial position of the mouthpiece relative to the liquid storage portion. The second fluid permeable portion 22 of the reservoir 20 is blocked by the first sealing element 16 of the tubular airflow channel 26 of the mouthpiece. Consequently, the first fluid permeable portion 14 of the tubular airflow channel 26 of the mouthpiece is not in contact with the second fluid permeable portion 22, so that a transport of liquid aerosol-forming substrate from the reservoir 20 is blocked. The tubular airflow channel 26 of the mouthpiece also comprises a first air inlet tubular portion 17, which includes a first air inlet 17A. The liquid storage portion comprises a second air inlet tubular portion 40, which also includes a second air inlet 40A as indicated by the dashed lines in FIG. 9. The first air inlet tubular portion 17 covers the second air inlet 40A, so that no air, which entered the cartridge through the outer air inlets 24 can enter the tubular airflow channel. This position corresponds to the sixth rotational position of the mouthpiece relative to the liquid storage portion, wherein the first air inlet and the second air inlet do not overlap, thereby preventing airflow into the mouthpiece. The lower part of FIG. 9 shows a cross-sectional view along the plane denoted with the reference numeral 50 and indicated by the dashed line in the upper part of FIG. 9 through the first air inlet tubular portion and the second air inlet tubular portion. This lower part shows that the second air inlet 40A is covered by the first air inlet tubular portion 17, thereby preventing airflow into the mouthpiece. This first axial position and this third rotational position of the mouthpiece relative to the liquid storage portion prevents the formation of an aerosol from the liquid aerosol-forming substrate. The cartridge therefore may be stored in such a position that is child-proof.

FIG. 10 depicts in the upper part a cross-sectional view of the lower part of the cartridge wherein the tubular airflow channel 26 of the mouthpiece has been fully inserted into the liquid storage portion by an axial movement of the mouthpiece relative to the liquid storage portion indicated by the arrow 21. This axial position of the mouthpiece relative to the liquid storage portion corresponds to the second axial position of the mouthpiece relative to the liquid storage portion. In this second final axial position the first fluid permeable portion contacts the whole inner surface of the second fluid permeable portion so that a maximum amount of liquid aerosol-forming substrate can be transported. As already described above with regard to FIG. 6 in this second axial position a flow path for the liquid aerosol-forming substrate from the second fluid permeable portion 22 to the first fluid permeable portion 14 to the porous susceptor 15 is present. This flow path allows the flow of liquid aerosol-forming substrate to the susceptor for the formation of the aerosol (porous susceptor 15 not shown in FIG. 10). As indicated by the arrow 23, the mouthpiece has been rotationally moved with regard to the liquid storage portion, so that the first air inlet tubular portion 17 does not cover the second air inlet 40A anymore. In this seventh rotational position of the mouthpiece relative to the liquid storage portion the first air Inlet and the second air inlet completely overlap, thereby allowing a maximum of airflow into the mouthpiece. The lower part of FIG. 10 shows a cross-sectional view along the plane with the reference numeral 50 and indicated by the dashed line in the upper part of FIG. 10 through the first air inlet tubular portion and the second air inlet tubular portion. This lower part shows that the first air inlet tubular portion 17 is completely retracted from the second air inlet, so that first air inlet 17A and the second air inlet 40A completely overlap, allowing a maximum amount of air to pass through. This second axial position and this seventh rotational position of the mouthpiece relative to the liquid storage portion allows the formation of an aerosol employing the maximum amount of aerosol and the maximum amount of air.

FIG. 11 shows in the upper part a cross-sectional view of the lower part of the cartridge wherein the mouthpiece and the liquid storage portion are in a second axial position relative to each other, wherein the first fluid permeable portion contacts the whole surface of the second fluid permeable portion allowing the transport of the maximum amount of liquid aerosol-forming substrate for aerosol formation. The area of contact between the first fluid permeable portion and the second fluid permeable portion is indicated by the dashed lines. In contrast to FIG. 10, the mouthpiece and the liquid storage portion are in an intermediate nineth rotational position, wherein the first air inlet 17A and the second air inlet 40A only partially overlap to half of the maximum overlap. This allows an intermediate amount of air to pass through the first air inlet and second air inlet. The lower part of FIG. 11 shows a cross-sectional view along the plane with the reference numeral 50 and indicated by the dashed line in the upper part of FIG. 11 through the first air inlet tubular portion and the second air inlet tubular portion. This lower part shows that the first air inlet tubular portion 17 still covers half of the second air inlet 40A, so that only half of the maximum amount of air can pass through. This second axial position and this intermediate nineth rotational position of the mouthpiece relative to the liquid storage portion allows the formation of an aerosol employing the maximum amount of liquid aerosol-forming substrate and roughly half of the maximum amount of air.

FIG. 12 shows in the upper part a cross-sectional view of the lower part of the cartridge 10. The mouthpiece and the liquid storage portion are in an intermediate axial position with regard to each other. In this intermediate axial position the first fluid permeable portion only partially contacts the second fluid permeable portion of the reservoir. The area of contact between the first fluid permeable portion and the second fluid permeable portion is indicated by the dashed lines. Similar to FIG. 11, the mouthpiece and the liquid storage portion are in an intermediate nineth rotational position wherein only half of the maximum amount of the air can pass through the first air Inlet and the second air inlet. This intermediate second axial position and this intermediate nineth rotational position of the mouthpiece relative to the liquid storage portion allows the formation of an aerosol employing only a part of the amount of liquid aerosol-forming substrate and half of the maximum amount of air.

1.-15. (canceled)

16. A cartridge for an aerosol-generating device, the cartridge comprising:
a mouthpiece comprising
a first fluid-permeable portion, and
a first air inlet; and
a liquid storage portion comprising
a reservoir configured to hold a liquid aerosol-forming substrate,
a second fluid-permeable portion in fluid contact with the reservoir, and
a second air inlet,
wherein the mouthpiece and the liquid storage portion are axially movable with respect to each other,
wherein a degree of contact between the first fluid-permeable portion and the second fluid-permeable portion is controllable by the axial movement between the mouthpiece and the liquid storage portion,
wherein the mouthpiece and the liquid storage portion are rotationally movable with respect to each other, and
wherein a degree of overlap between the first air inlet and the second air inlet is controllable by rotational movement between the mouthpiece and the liquid storage portion.

17. The cartridge according to claim 16,
wherein the mouthpiece further comprises a tubular airflow channel, and
wherein the first fluid-permeable portion is arranged at a distal portion of the tubular airflow channel.

18. The cartridge according to claim 16, wherein the mouthpiece further comprises a first sealing element arranged distal of the first fluid-permeable portion.

19. The cartridge according to claim 18, wherein the first sealing element is configured as a tubular sealing element.

20. The cartridge according to claim 18, wherein the mouthpiece and the liquid storage portion are axially movable with respect to each other in a first position, in which the first sealing element sealingly covers the second fluid-permeable portion of the liquid storage portion.

21. The cartridge according to claim 16, wherein the mouthpiece and the liquid storage portion are axially movable with respect to each other in a second position, in which the first fluid-permeable portion contacts a whole inner surface of the second fluid-permeable portion.

22. The cartridge according to claim 16,
wherein the mouthpiece and the liquid storage portion are incrementally axially movable to at least one intermediate axial position between the first position and second position, and
wherein the first fluid-permeable portion only partially contacts the whole inner surface of the second fluid-permeable portion in the intermediate axial position.

23. The cartridge according to claim 16, wherein the mouthpiece further comprises a second sealing element arranged proximal of the first fluid-permeable portion.

24. The cartridge according to claim 23, wherein the second sealing element is configured as a ring-shaped sealing element.

25. The cartridge according to claim 16, wherein the first air inlet enables lateral airflow into the mouthpiece.

26. The cartridge according to claim 16, wherein the liquid storage portion further comprises a central tubular cavity configured to at least partly receive the mouthpiece.

27. The cartridge according to claim 26, wherein the second air inlet enables lateral airflow into the central tubular cavity of the liquid storage portion.

28. The cartridge according to claim 16, wherein the mouthpiece and the liquid storage portion are rotationally movable with respect to each other in a sixth position, in which the first air inlet and the second air inlet do not overlap thereby preventing airflow into the mouthpiece.

29. The cartridge according to claim 28, wherein the mouthpiece and the liquid storage portion are rotationally movable with respect to each other in a seventh position, in which the first air inlet and the second air inlet fully overlap thereby allowing airflow into the mouthpiece.

30. The cartridge according to claim 29,
wherein the mouthpiece and the liquid storage portion are incrementally rotationally movable from the sixth position to the seventh position, and
wherein the first air inlet and the second air inlet only partially overlap.

31. The cartridge according to claim 16, wherein the mouthpiece further comprises a susceptor.

32. The cartridge according to claim 31, wherein the susceptor is tubular and aligned with the first fluid-permeable portion.

33. The cartridge according to claim 31, wherein the susceptor is porous.

34. The cartridge according to claim 31, wherein the susceptor is in fluid communication with the first fluid-permeable portion.

35. An aerosol-generating system comprising the cartridge according to claim 16 and an aerosol-generating device, wherein the aerosol-generating device comprises a cavity configured to receive the cartridge.
